(19) United States
(12) Patent Application Publication
(10) Pub. No.: US 2016/0267081 A1
(43) Pub. Date: Sep. 15, 2016

(54) STORY CAPTURE SYSTEM

(71) Applicant: everyStory, Inc., San Diego, CA (US)

(72) Inventor: David Keene, San Diego, CA (US)

(21) Appl. No.: 15/069,310

(22) Filed: Mar. 14, 2016

Related U.S. Application Data
(60) Provisional application No. 62/132,401, filed on Mar. 12, 2015.

(51) Int. Cl. G06F 17/30

(52) U.S. Cl. CPC G06F 17/3005; G06F 17/30023

(57) ABSTRACT

A device also includes a transceiver configured to communicate with a database and a first user device and a processor operatively coupled to the user interface, a microphone, a speaker, and the transceiver. The processor is configured to receive a first image from the database and receive from the first user device a first message. The first message includes a request for information related to the first image. The processor is also configured to record via the microphone an audio recording that includes information related to the first image, transmit the audio recording to the database, and transmit to the database a request for the first image. The processor is further configured to receive the first image with an identifier of the audio recording and cause a user interface to display the first image and simultaneously cause the speaker to play the audio recording.

### CROSS REFERENCE TO RELATED APPLICATIONS

The present application claims the priority to U.S. Provisional Application No. 62/132,401 filed Mar. 12, 2015, which is incorporated herein by reference in its entirety.

### BACKGROUND

The following description is provided to assist the understanding of the reader. None of the information provided or references cited is admitted to be prior art. As family members grow older, some of the stories that they knew are lost. While oral traditions can be maintained, the oral traditions may not be accurate over time. Also, some people prefer to hear the story as told by those who witnessed the event, personally knew the story subjects, etc.

### SUMMARY

An illustrative device includes a user interface configured to display information and receive user input, a microphone configured to detect sound, and a speaker configured to transmit sound. The device also includes a transceiver configured to communicate with a database and a first user device and a processor operatively coupled to the user interface, the microphone, the speaker, and the transceiver. The processor is configured to receive a first image from the database and receive from the first user device a first message. The first message includes a request for information related to the first image. The processor is also configured to record via the microphone an audio recording that includes information related to the first image, transmit the audio recording to the database, and transmit to the database a request for the first image. The processor is further configured to receive the first image with an identifier of the audio recording and cause the user interface to display the first image and simultaneously cause the speaker to play the audio recording.

An illustrative method includes receiving, by a processor of a first user device, a first image from a database and receiving, by the processor, a first message from the second user device. The first message includes a request for information related to the first image. The method also includes recording, by the processor and via a microphone of the first user device, an audio recording that includes information related to the first image, transmitting the audio recording to the database, and transmitting to the database a request for the first image. The method also includes receiving the first image with an identifier of the audio recording and simultaneously causing, by the processor, a user interface of the first user device to display the first image and causing a speaker of the first user interface to play the audio recording.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a network in accordance with an illustrative embodiment.

FIGS. 2 and 3 are diagrams of stored content in accordance with an illustrative embodiment.

FIG. 4 is a diagram of a user interface display in accordance with an illustrative embodiment.

FIG. 5 is a diagram of a navigation page display of a user interface in accordance with an illustrative embodiment.

FIG. 6 is a sequence diagram of storing audio in accordance with an illustrative embodiment.

FIGS. 7-22 are screenshots of a user interface in accordance with an illustrative embodiment.

FIG. 23 is an illustration of a photo book in accordance with an illustrative embodiment.

FIG. 24 is a block diagram of a computing device in accordance with an illustrative embodiment.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Families have been sharing stories orally for generations. It is one of the most common pastimes at family gatherings all over the world. Looking through old photo albums as reference for stories provides an incredibly organic process for story flow. After a story is shared, the story typically is not saved beyond the memory of the persons who had heard it. Also, stories sound and feel different when retold by a secondary source. Great stories and crucial details within stories are frequently lost as time passes.

A computerized story capture system provides a digital service that makes it easy to create a high fidelity digital archive of a family's stories for preservation for the next generation. In some embodiments, the computerized story capture system allows people to browse through their photos while recording audio of the stories as they are organically told. In some embodiments, the computerized story capture system permits the user to naturally tell the story by choosing any photos they wish instead of only being able to record the audio over photos in a pre-ordered way such as a slideshow.

In some embodiments, the computerized story capture system enables users to record long running audio with no time limits and link that audio to photos to add context to the stories being told. Users can playback this audio as recorded (linear playback) or mixed with audio recorded at a different date (non-linear playback).

By way of example, a user could listen to all the audio recorded while the people speaking were looking at a particular image. The playback for a particular photo would play audio from 1:12:00 of a first two-hour recording session, 0:45:00 of a second one-hour recording session, and 00:01:00 of a third three-hour session. In an example embodiment, the audio is stored in a networked storage system, such as “the cloud,” not locally to the playback device.

Some embodiments of a computerized story capture system provide several advantageous features. For example, some embodiments allow a user to quickly download and seek to a specific point in each audio session without incurring the latency and bandwidth costs of downloading the whole clip. Some embodiments avoid holding open communication connections for streaming during recording and playback.

In an illustrative embodiment, user devices such as smartphones can be used to send an image to other user devices with a request for information regarding the image. For example, Amy can send an image of her grandfather to Steve, Amy's uncle. The image can be of Amy's grandfather holding a large fish in front of a lake. Steve can receive the image on his smartphone with a request from Amy asking Steve to explain the context of the image. In an illustrative embodiment, Steve can provide a response to Amy in the form of text, such as, “This photo was taken on one of our annual fishing trips to Canada when I was a kid.” In an alternative embodiment, Steve can record, via his smartphone, himself telling a story about the photo. For example, Steve can discuss the trip to Canada, how his dad struggled to get the fish into the boat, and how Steve was so excited that his hands were shaking when he took the photo of his dad, which explains why the photo is blurry. The explanation of the photo (e.g., whether in text format or audio format) can be stored in connection with the image. In an illustrative embodiment, Amy, her sisters, and other family members can access the photo and the explanation at a later time to reminisce, thereby preserving the memory.

As explained in greater detail below, various embodiments described herein provide functions and features that were not previously possible. For example, in some embodiments, a slideshow or photo album is presented to a user that includes a narration of one or more photos. The content of the slideshow or photo album can be accessed electronically virtually anywhere and at any time regardless of the availability of the narrator (e.g., whether the narrator is busy, ill, or deceased).

In some embodiments, a slideshow or photo album with associated audio recordings can provide advantages that were not previously available. For example, audio recordings can allow a person to explain the context and story surrounding a photo that would not be known by simply viewing the photo. Also, prompting a narrator for details about a photo or a story can allow the narrator to remember additional details, stories, or context that the narrator would not have otherwise provided. Recording such content preserves the stories and context in a manner that captures more of the emotion regarding the photo, story, or narrator than a simple photo or text-based explanation can. Additionally, various embodiments described herein make it more convenient and easier for people to record their stories or explanations of photos, thereby increasing, for example, the amount of familial history that is preserved. For example, very few individuals write memoirs about their life for their family members to cherish because it can be difficult or the individuals are uninterested in writing a memoir. However, various embodiments described herein makes it easy for virtually everyone to record stories and their own history. Furthermore, many people enjoy telling stories but do not enjoy writing.

Thus, various embodiments can be used to capture and preserve memories by making replay of the memories more enjoyable. Many people find it easier and more compatible with the human sensory system to watch and listen (e.g., to a slideshow of family histories while listening to a family member describe the photos) than to read a memoir. For example, it can be more enjoyable to listen to a story with a slideshow of relevant pictures than to sit and read a memoir. Various embodiments can make it easier to record their memories by simply telling a story related to associated photos.

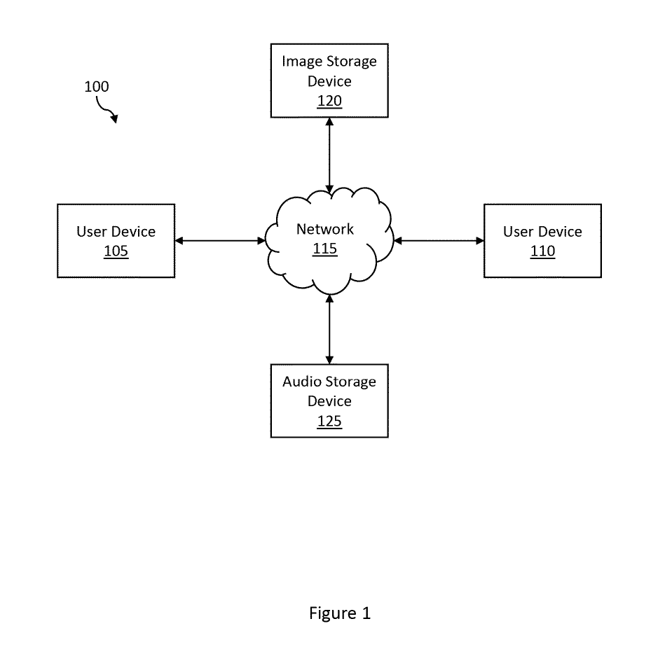

FIG. 1 is a block diagram of a network in accordance with an illustrative embodiment. The system 100 of FIG. 1 includes a user device 105, a user device 110, a network 115, an image storage device 120, and an audio storage device 120. In alternative embodiments, additional, fewer, and/or different elements may be used.

The user device 105 and the user device 110 can be any suitable device that can communicate with each other, the network 115, the image storage device 120, and the audio storage device 125. For example, the user device 105 or the user device 110 can be a smartphone, a tablet, a personal computer, a laptop, a server, etc. In an illustrative embodiment, the user device 105 and/or the user device 110 include a camera configured to capture an image (e.g., a still image or a video). In an illustrative embodiment, the user device 105 and/or the user device 110 include a microphone configured to capture audio, such as one or more users speaking. The user device 105 and the user device 110 can include user interfaces. For example, the user interfaces can include a display for displaying images or text to the user. The user interfaces can receive user input from, for example, a touch screen, a keyboard, a mouse, etc.

The user device 105 and the user device 110 can communicate with each other and with the image storage device 120 and the audio storage device 125 via the network 115. The network 115 can include any suitable communication network such as a local-area network (LAN), a wide-area network (WAN), the Internet, wireless or wired communications infrastructure, servers, switches, data banks, etc.

The image storage device 120 stores images. In an illustrative embodiment, the image storage device 120 is a server connected to the internet. In an alternative embodiment, the image storage device 120 is memory of the user device 105 and/or the user device 110. Although the block diagram of FIG. 1 shows the image storage device 120 as a single block, the image storage device 120 can include multiple devices, such as multiple servers, multiple user devices (e.g., the user device 105 and the user device 110), etc.

The audio storage device 125 stores images. In an illustrative embodiment, the audio storage device 125 is a server connected to the internet. In an alternative embodiment, the audio storage device 125 is memory of the user device 105 and/or the user device 110. Although the block diagram of FIG. 1 shows the audio storage device 125 as a single block, the audio storage device 125 can include multiple devices, such as multiple servers, multiple user devices (e.g., the user device 105 and the user device 110), etc. In an illustrative embodiment, the image storage device 120 and the audio storage device 125 are implemented in the same device.

In some embodiments, image and audio data is stored on one or more servers and transmitted to a user device in segments, thereby reducing the amount of information transmitted to and stored on the user device. In an illustrative embodiment, audio recordings are associated with one or more images. Similarly, in such embodiments, an image can be associated with one or more audio recordings or portions of audio recordings. A database or record can be kept (e.g., on a server of the network 115, on the image storage device 120, on the audio storage device 125, etc.) that maintains such associations between images and audio recordings (or segments of audio recordings). In response to a user device requesting to download an image, a server of the network 115 can check such a database or record to determine associated audio recordings. The server can transmit to the user device the image and a listing of the associated audio recordings. Similarly, in response to a user requesting to play an audio recording, the server can transmit to the user device a listing of the images associated with the audio recording.

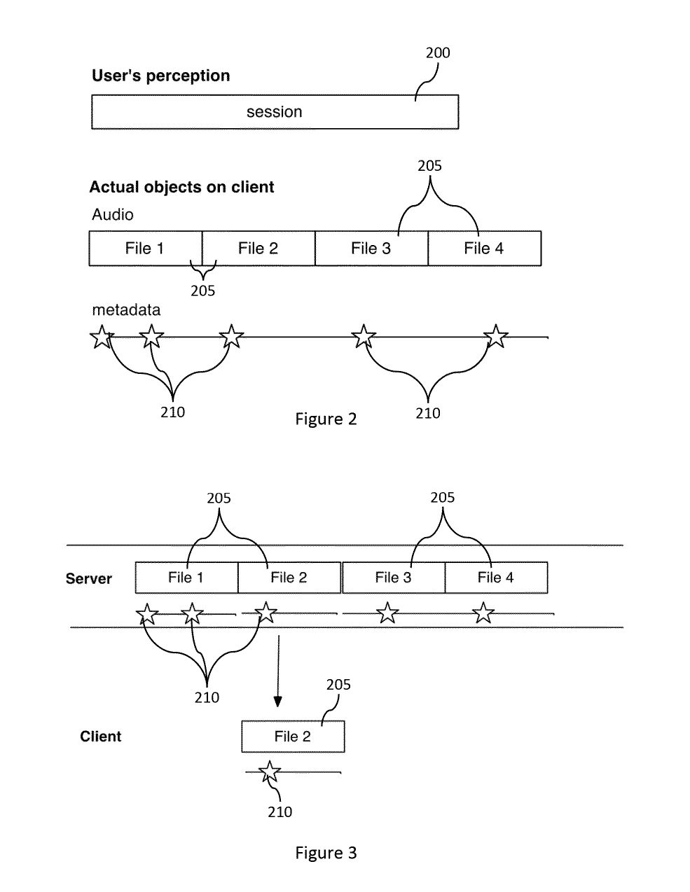

FIGS. 2 and 3 are diagrams of stored content in accordance with an illustrative embodiment. The diagrams include a session 200, audio files 205, and metadata 210. In alternative embodiments, additional, fewer, and/or different elements may be used.

In the embodiment illustrated in FIG. 2, the session 200 is diagrammatic of a viewing session of a story as experienced by a user. In an illustrative embodiment, the story includes a voice-over while various images are displayed on a screen. For example, the story can be of a grandmother narrating or explaining various photos. As the narration or explanation progresses, various photos can be displayed related to the story. For example, the grandmother's voice can be recorded as she talks about photos. A photo album can be displayed on a user device. The user device can record the grandmother's voice (or any other suitable audio content) and detect which photo is selected during the narration. For example, photos can be flipped through or otherwise navigated while the grandmother tells the story. The session 200 can be a replay of the recorded audio along with a display of the photo that was selected at the particular times during the recording. In an illustrative embodiment, screen touches can be recorded during the audio recording. The screen touches can be replayed with the replay of the audio recording.

As shown in FIG. 2, the session 200 does not include breaks or segments indicative of multiple files. That is, the user can replay the session 200 as if the session is a continuous file. The session 200 can be composed of multiple audio files 205. For example, the session 200 can be broken up or parsed into the multiple audio files 205. The audio files 205 can be stored on a server, such as the audio storage device 125. The server can also store metadata 210 with the audio files 205. The metadata 210 can indicate which image was selected during the recording of the audio files 205. The metadata 210 is shown in FIG. 2 along a timeline corresponding to the sequential audio files 205.

In an illustrative embodiment, metadata associated with the audio recording can include an indication of who is speaking. For example, an audio recording can include multiple people speaking about a photo. The metadata can be used to indicate who is speaking at any particular instance. A user can add or edit the metadata to include names of individuals and when individuals begin and/or stop speaking. In an illustrative embodiment, during the recording, a user can select one of a plurality of individuals to indicate who is speaking. The selection of the individuals can be stored as metadata of the audio recording. During replay of the audio recording, an indication of who is speaking (e.g., who was selected during the recording) can be displayed.

In an illustrative embodiment, metadata associated with screen touches can be stored with the audio recording. For example, while recording, the user device tracks where a user taps or gestures on the photo during the recording. The user device records the places where the user has tapped or interacted with a displayed image. During playback, the touches or interactions with the touch screen can be displayed. In some embodiments, recognized gestures such as shapes cause a function to be performed, such as displaying a graphic. Interactions with the image can include zooming in or out, circling faces, drawing lines, etc.

In an illustrative embodiment, along with the audio recording, the user device can record a video of the user during the audio recording. The video can be played back during the playback of the audio recording. For example, a viewing window can be displayed for the video during playback while the image about which the subject is talking is simultaneously displayed. In an illustrative embodiment, the viewing window is displayed on the screen while the audio and video are recording. The user can move the viewing window around the screen during recording (e.g., to view a portion of the image that is obstructed by the viewing window). The location of the viewing window during the audio recording can be recorded and played back during the audio playback. Thus, the viewer of the playback can see the same screen that was displayed during the recording.

In an illustrative embodiment, the user device can detect that during a recording, speaking has stopped. After a predetermined threshold of not detecting speech (e.g., ten seconds, twenty seconds, thirty seconds, one minute, ten minutes, etc.), the application can prompt the user to end the recording session (or continue the session). In an alternative embodiment, after a predetermined threshold of not detecting speech, a suggested question can be displayed to the user to facilitate explanation or story telling. For example, a selected image during a recording session can be tagged with Grandpa and Aunt JoAnn. After a predetermined threshold of silence, a pop-up display can ask, “What was Grandpa doing in this picture?” or “How old was Aunt JoAnn in this picture?” The questions can be selected based on the tags of an image, dates of when the image was captured, etc.

In an illustrative embodiment, a user device records the audio files 205 and the metadata 210 and breaks the session 200 into the multiple audio files 205 (and associated metadata 210) into portions, as shown in FIG. 2. The user device can upload the portions separately, thereby minimizing loss in the event of a communications malfunction or a computing crash. Uploading the portions separately minimizes the time that a streaming communication link is maintained, thereby increasing reliability of the communication.

In the embodiment illustrated in FIG. 2, the first audio file 205 (i.e., “File 1”) corresponds to two instances of metadata 210. Thus, during playback of the first audio file 205, the first instance of metadata 210 (i.e., the left-most star along the timeline) indicates an initial photo to be displayed during playback of the first audio file 205. As playback of the first audio file 205 progresses, the second instance of metadata 210 indicates a change in the photo displayed during the recording of the first audio file 210 and, therefore, the photo displayed during the playback of the first audio file 210.

In some embodiments, playback of the session 200 is not a full playback of the recordings from beginning to end. For example, a user can select a mid-way point to being recording. For example, the user can select an image corresponding to a particular metadata 210 or the user can select a point along a playback timeline. FIG. 3 shows a diagram of a user playing back a portion of the second audio file 205 (i.e., “File 2”). The second audio file 205 and the associated metadata is transmitted from the server (e.g., the audio storage device 125) to the user device for playback. In an illustrative embodiment, during playback of the session 200, individual audio files 205 are transmitted to the user device for playback, as needed, thereby reducing the total amount of memory and communication bandwidth required for the user device.

In an illustrative embodiment, a user interface display is provided on a user device to allow the user to navigate audio stories without leaving the context of the photos themselves. For example, the computerized story capture system includes a playback screen that puts linear progression horizontally on the page and uses vertical space to represent other stories that are available within the current context.

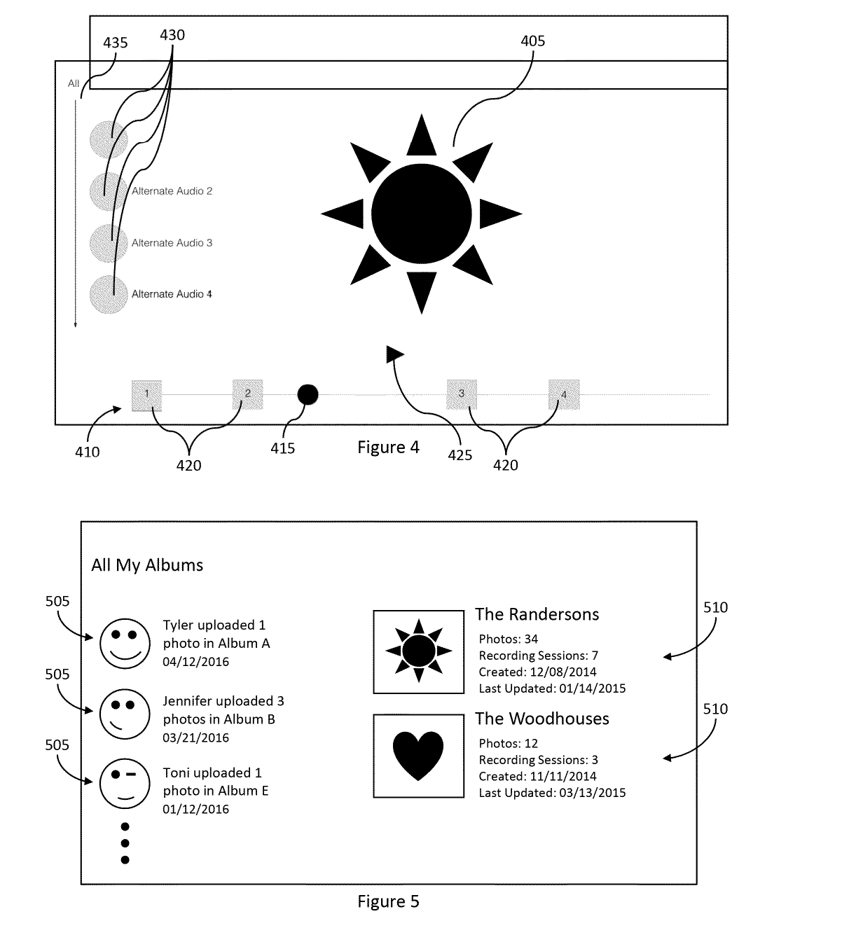

FIG. 4 is a diagram of a user interface display in accordance with an illustrative embodiment. The display of FIG. 4 includes a currently displayed image 405, a timeline 410, a timeline indicator 415, images 420, a control button 425, alternative audio buttons 430, and a play-all-associated-audio button 435. In alternative embodiments, additional, fewer, and/or different elements may be used.

In the display shown in FIG. 4, the timeline 410 is representative of a story session (e.g., a session 200). Along the timeline 410 can be images 420 that are representative of when the image displayed (e.g., thumbnails) during the playback of the story session. Thus, in the embodiment shown in FIG. 4, an image “1” is initially displayed. As the story progresses along the timeline and the audio is played back, an image “2” is displayed, then an image “3” is displayed, and then an image “4” is displayed. The images displayed are those that were displayed at the respective time during the recording of the story. The timeline indicator 415 can indicate where along the timeline the current playback is located. In the embodiment of FIG. 4, the currently displayed image 405 corresponds to the image “2” along the timeline 410. A control button 425 can be used to control the playback of the story session. For example, the control button 425 can include a play button, a stop button, a pause button, a fast forward button, a rewind button, etc.

In the embodiment illustrated in FIG. 4, the alternative audio buttons 430 can be used to navigate to other recorded stories associated with the currently displayed image 405. The alternative audio buttons 430 can be used to navigate to another audio story that included the currently displayed image 405. In an illustrative embodiment, the play-all-associated-audio button 435 can be used to play all of the audio associated with the alternative audio buttons 430.

FIG. 5 is a diagram of a navigation page display of a user interface in accordance with an illustrative embodiment. The display of FIG. 5 includes thumbnails 505 and albums 510. In alternative embodiments, additional, fewer, and/or different elements can be used.

In an illustrative embodiment, the various content (e.g., images, videos, audio recordings) can be organized in multiple ways to allow a user to navigate through the content. For example, the content can be found by selecting the person who uploaded the image or an album that the content is associated with. For example, the display of FIG. 5 includes multiple thumbnails 505 of images that have been uploaded. As shown in FIG. 5, next to the thumbnails 505 can be information related to the respective thumbnail 505 such as which individual or user uploaded an image, which album the image is associated with, and when the image was uploaded. Selecting one of the thumbnails 505 can display the image associated with the thumbnail 505 (e.g., via the display illustrated in FIG. 4) or to a display of other images in the album in which the image associated with the thumbnail 505 is.

The display of FIG. 5 also includes albums 510. Next to an example image of the album 510 (e.g., one of the images in the album 510) is information related to the album 510 such as a title (e.g., “The Randersons” for an album related to a visit to the neighbor's Fourth of July bar-b-que), the number of photos in the album, when the album was created, and when the last time the album was updated. Selecting one of the albums 510 can display images in the album 510.

In an illustrative embodiment, the various images in an album can be displayed using keywords that a user associates with images, locations of where the images were taken, people tagged in the images, dates of when the images were taken, etc. For example, images can be organized based on date ranges, such as decades (e.g., 1960s, 1970s, 1980s, etc.). In an alternative embodiment, the various images are organized by a popularity rating (e.g., based upon the number of times each image is viewed or downloaded). In an illustrative embodiment, images that have associated recordings can be marked as such. For example, a speech bubble can be displayed in the corner of the thumbnail of an image in an album.

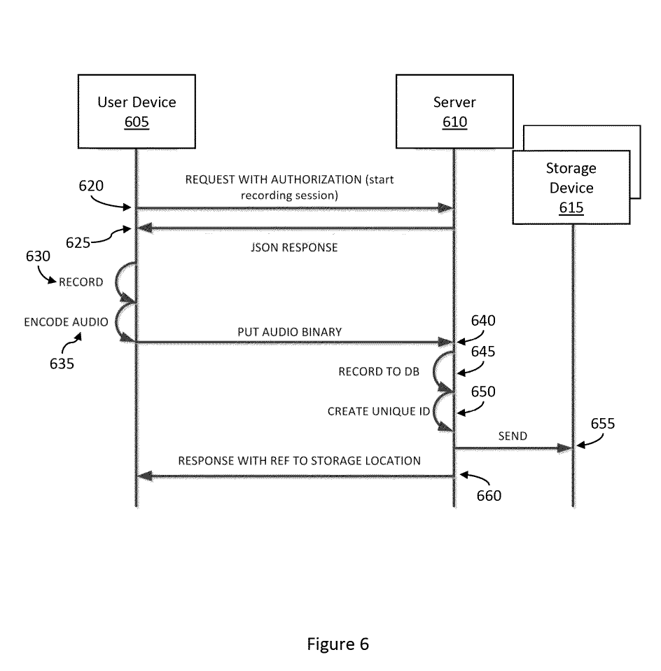

As explained above with regard to FIGS. 2 and 3, images and audio can be stored on a remote server (e.g., as opposed to being stored on the user device). FIG. 6 is a sequence diagram of storing audio in accordance with an illustrative embodiment. The sequence diagram of FIG. 6 includes a user device 605, a server 610, a storage device 615, and operations 620 through 660. In alternative embodiments, additional, fewer, and/or different elements and/or operations may be used. Also, the use of a sequence diagram is not meant to be limiting with respect to the order or flow of operations. For example, in an illustrative embodiment, two or more of the operations may be performed simultaneously.

The user device 605 is any suitable user device, such as the user device 105 or the user device 110. The server 610 can be any suitable computing device, such as a computing device or server associated with the network 115. The storage device 615 can be any suitable storage device, such as the image storage device 120 and/or the storage device 125.

The sequence diagram of FIG. 6 shows the operations for storing an audio recording from the user device 605. For example, the audio recording can be recorded while an image is being displayed on the user device 605. In an operation 620, the user device 205 transmits a request to start a recording session. The request can include credentials and/or authorization to store audio, for example, with reference to a particular image. In an operation 625, the server 610 transmits a JSON response indicating that the user device 605 can initiate the recording. JSON is a type of data. In an illustrative embodiment, the application program interface (API) uses JSON data and is written in the Java programming language. In alternative embodiments, any suitable data format can be used. In an illustrative embodiment, the operation 625 includes the server 610 indicating to the user device 605 a location to store recorded audio (e.g., on a computing cloud, on the audio storage device 125, etc.).

In the operation 630, the user device 605 records audio. In an operation 635, the recorded audio is encoded. In an illustrative embodiment, encoding the audio includes breaking the recorded session (e.g., the session 200) into segments (e.g., the audio files 205). In illustrative embodiment, encoding the audio includes formatting an audio file and/or encrypting the audio file. In an operation 640, the user device 605 transmits to the server 610 the audio file(s) and any associated metadata (e.g., the metadata 210).

In an operation 645, the server 610 stores the received audio in a storage repository. In an illustrative embodiment, the received audio is stored in an adjunct storage near a database. In an operation 650, a unique identifier is created for the received audio. In an illustrative embodiment, the unique identifier for the received audio is stored in a database or the storage with an indication of associated images or metadata. In an illustrative embodiment, the unique identifier identifies the received audio file among other received audio files.

In an operation 655, the recorded audio is transmitted to the storage device 615 for storage. In an illustrative embodiment, the recorded audio is stored in the storage device 615 with the unique identifier such that the server 610 or the user device 605 can use the unique identifier to request the recorded audio from the storage device 615. In an operation 660, the server 610 transmits a response to the user device 605 that includes a reference to the storage location of the recorded audio. In an illustrative embodiment, the reference includes the unique identifier.

In an illustrative embodiment, the user device 605 does not store the recorded audio after the audio is stored on the storage device 615. Thus, the recorded audio does not require long-term storage space in memory of the user device 605. Further, other user devices 605 (e.g., user devices 605 of friends or family) can access the recorded audio from the storage device 615. In an illustrative embodiment, the recorded audio can be converted into a text file. For example, speech recognition can be used to convert the recorded audio to text. The text associated with the recorded audio can be stored in the storage device 615. In an illustrative embodiment, the text of the recorded audio can be searchable by a user of the user device 605 to locate specific audio clips. In an alternative embodiment, the text can be displayed via the user device 605, such as in lieu of or along with a playback of the recorded audio.

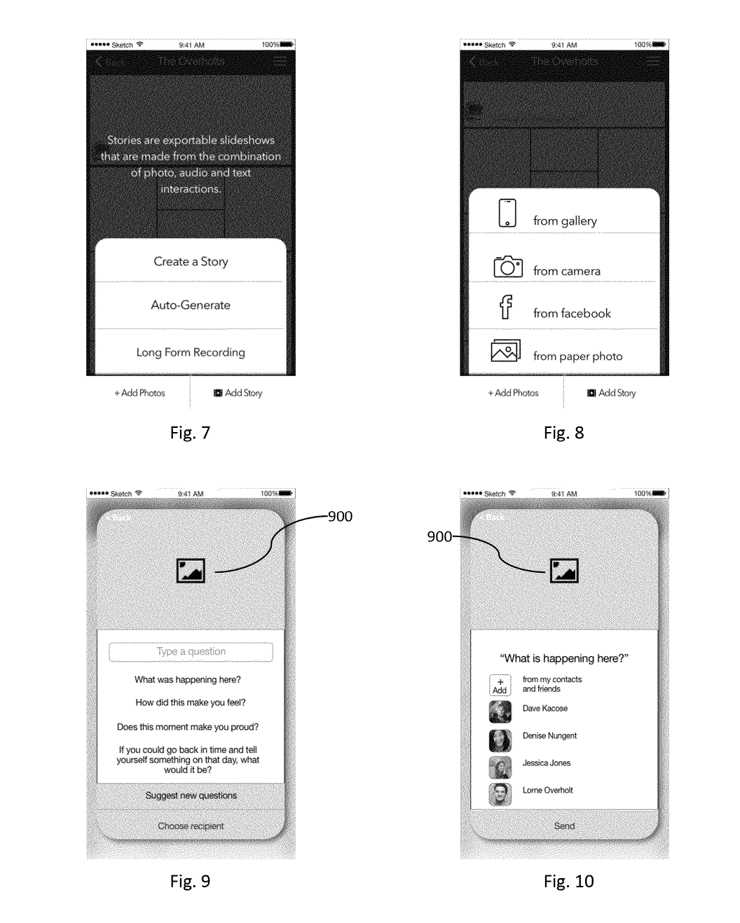

In an illustrative embodiment, a user can request that another user input an annotation to an image. The annotation can be in the form of a short text answer, a long text answer, an audio recording, a video recording, etc. The annotation can be stored along with the image to be recalled later by either user or another user. FIGS. 7-22 are screenshots of a user interface in accordance with an illustrative embodiment. In alternative embodiments, additional, fewer, and/or different elements may be used. The screenshots shown in FIGS. 7-22 are taken from a smart phone such as the user device 105, the user device 110, the user device 605, etc. In an illustrative embodiment, the screenshots are of an application or program running on a smart phone. In alternative embodiments, any suitable user device can be used such as a computer, a tablet, etc.

FIG. 7 is a screenshot of a menu screen in accordance with an illustrative embodiment. As seen in FIG. 7, a user can be prompted to select a “Create a Story,” an “Auto-Generate” (e.g., a Story), or a “Long-Form Recording” button. In an illustrative embodiment, the “Create a Story” button, when selected, guides a user to creating a story. In an illustrative embodiment, a story is a slideshow of photos that can include text and/or audio. For example, a story can be a slide show of multiple photos that were each annotated separately. In some embodiments, a story can include one or more audio recordings and/or text of an image. In an illustrative embodiment, the “Auto-Generate” button, when selected, will compile a slideshow of photos. For example, the slideshow can be composed of photos that were taken on the same day. In another example, the slideshow can be composed of photos that are already annotated. In an illustrative embodiment, the “Long Form Recording” button, when selected, begins recording audio and tracks photos that the user views during the audio recording (e.g., records the session 200).

FIG. 8 is a screenshot of an upload image view in accordance with an illustrative embodiment. As seen in FIG. 8, a user can select to upload an image by selecting from a gallery of images stored on the user device but not imported into the working memory of the application. In an alternative embodiment, the user can select to upload an image by selecting from a gallery of images stored on the user device that have not been selected by the user as being accessible by the application. The user can select to capture an image with a camera associated with the user device. The user can select to upload an image from a remote server. For example, the application can be used to access an image database on the image storage device 120, a website (such as Facebook®), or any other suitable database that is accessible to the user device, such as a disk drive of a local area network. The user can select to capture an image from a paper photograph. In an illustrative embodiment, selecting the “from paper photo” button presets settings of the image capture device associated with the user device to capture an image of a paper photograph. For example, the settings for the camera can be set to auto-focus on a close object because the camera lens will be relatively close to the photo while the image of the paper photograph is likely to be taken. In an alternative embodiment, selecting the “from paper photo” button initiates a device of the user device that can be used to scan in a paper photograph.

In an illustrative embodiment, a user can select a photo and transmit the photo to another user's user device for comment and/or annotation. FIG. 9 is a screenshot of a user interface prompting a user to ask another user a question. For example, the user can ask a question related to the photo 900. For example, the user of the user device selected a photo 900 that is displayed at the top of the user interface. On the bottom of the user interface, the user is presented with suggested questions. In an illustrative embodiment, the suggested questions are predetermined. In an alternative embodiment, at least some of the suggested questions are questions that the user previously asked another user. For example, as shown in FIG. 9, the user can be asked to “Type a question” in an input box. The user can also be presented with questions that the user previously typed for another photo or another user. As shown in FIG. 9, the suggested questions can include, for example, “What is happening here?”; “How did this make you feel?”; “Does this moment make you feel proud?”; and “If you could go back in time and tell yourself something on that day what would it be?” In an illustrative embodiment, the user can be presented with a button “Suggest new questions” that will re-populate the suggested questions with other suggested questions.

In an illustrative embodiment, after the user selects a question to ask related to the photo 900, the user can be prompted to select another user to send the selected question to. FIG. 10 is a screenshot of a user interface prompting a user to select another user to send the selected question to. In the embodiment shown in FIG. 10, the user has selected to ask “What is happening here?” As shown in FIG. 10, a list of suggested other users can be presented to the user. The list of suggested other users can be determined based on, for example, previous other users the user has selected, other users that have access to the photo 900, other users that are tagged in the photo 900, or any other suitable criteria. As shown in FIG. 10, the user can select a contact from a contacts list, such as a contacts list stored on the user device. After a user selects another user to send the question to, the user device can transmit to a user device of the other user the photo 900 and the question (e.g., “What is happening here?”).

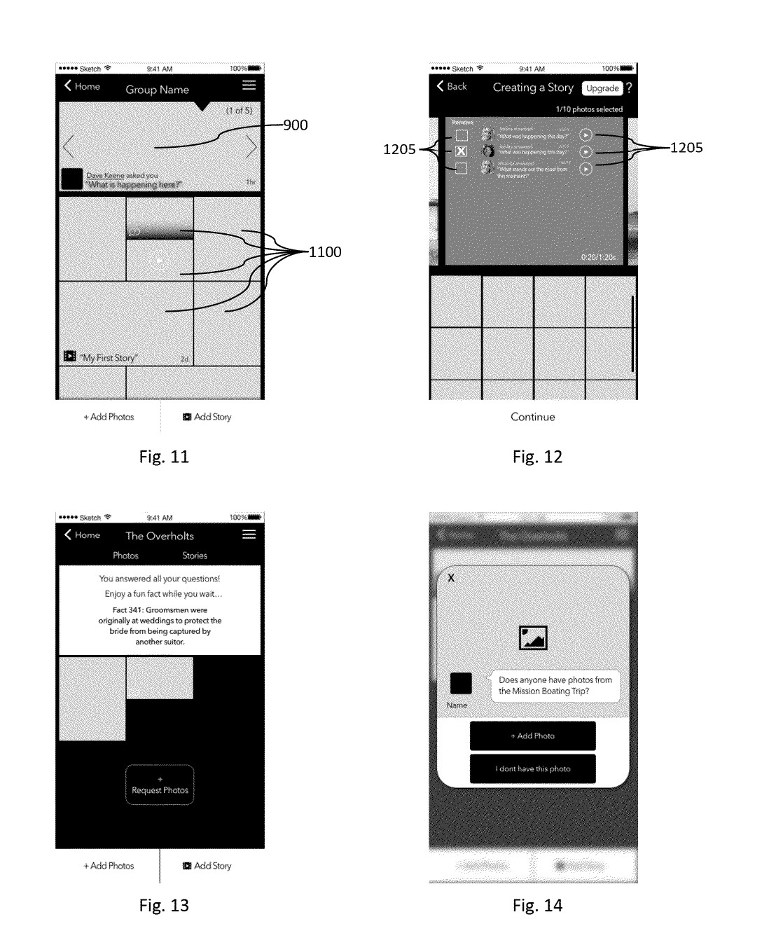

FIG. 11 is a screen shot of a user interface prompting a user to answer a question. For example, the user interface of FIG. 11 can be presented to a user after the user of the user interface of FIG. 10 transmitted the photo 900 and the question “What is happening here?” In the embodiment illustrated in FIG. 10, the user can be presented with a plurality of other images 1100 (which can include albums) that are associated with the user's account.

In an illustrative embodiment, multiple users can contribute to the creation of a story. For example, FIG. 12 is a screen shot of a user interface showing a management tool for managing a story. In the screen shot of FIG. 12, questions 1205 have been asked from multiple users regarding a photo or an album. The user presented with the screen shot of FIG. 12 can choose one of the boxes 1205 to remove an asked question from a photo or album. In the embodiment illustrated in FIG. 12, the user has selected to remove the middle question.

FIG. 13 is a screen shot of a user interface showing that the user does not have pending questions. For example, the screen shot of FIG. 13 can be presented to a user, for example, after the user has answered questions that were sent to the user.

FIG. 14 is a screen shot of a user interface in which a user is prompted to send a photo to another user. In the screen shot of FIG. 14, another user has asked the user of the interface of FIG. 14, “Does anyone have photos from the Mission Boating Trip?” The user is prompted to answer by transmitting one or more photos to the user who asked the question (e.g., by selecting the “+Add Photo” button) or by transmitting an answer by selecting the “I don't have the photo” button.

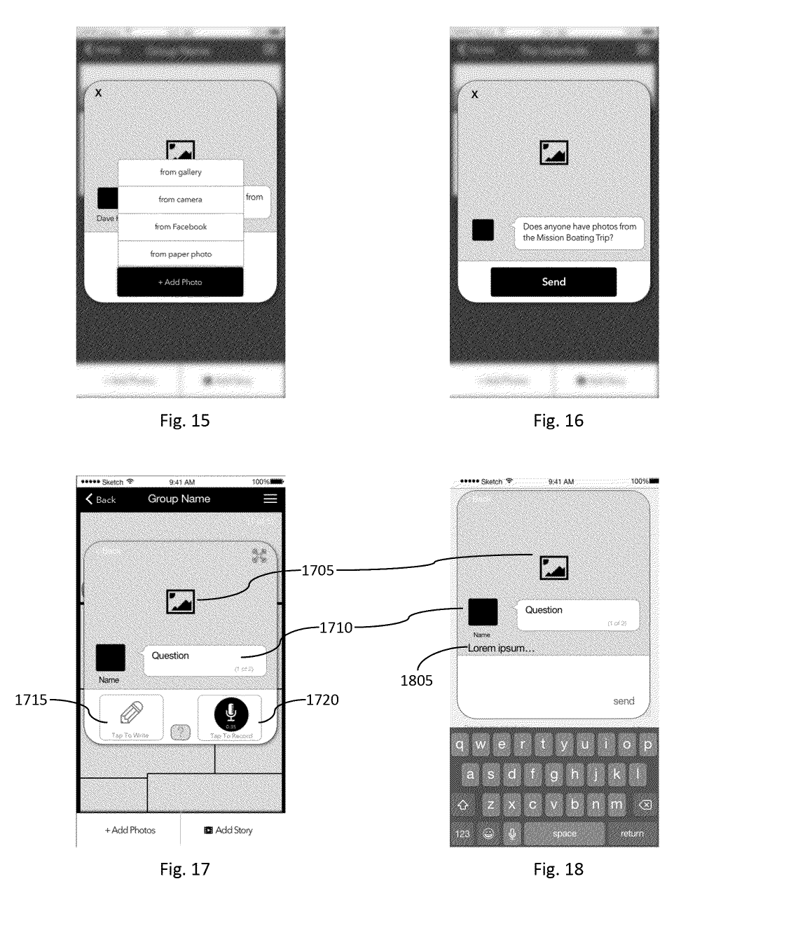

FIG. 15 is a screen shot of the user interface of FIG. 14 after the user selected the “+Add Photo” button. As shown in FIG. 15, the user can choose to select a photo from a gallery (e.g., a gallery of photos stored on the user device or a gallery of photos stored on the image storage device 120), from a camera of the user device, from a website (e.g., Facebook®), or from a paper photo. After the user has selected a photo to send to the user that requested photos of the Mission Boating Trip, the user can be prompted to send the photo, such as with the screen shot of FIG. 16.

FIG. 17 is a screen shot of a user interface prompting a user to answer a question. In the embodiment illustrated in FIG. 17, another user has asked the user of the user interface to answer a question 1710 regarding a photo 1705. The user can be prompted to answer the question by entering text by selecting the “Tap to Write” button 1715 or by recording audio by selecting the “Tap to Record” button 1720. The screen shot of FIG. 18 is displayed after the user selected the “Tap to Write” button 1715 of FIG. 17. The user can type an answer 1805 via a keyboard presented to the user at the bottom of the screen shot of FIG. 18.

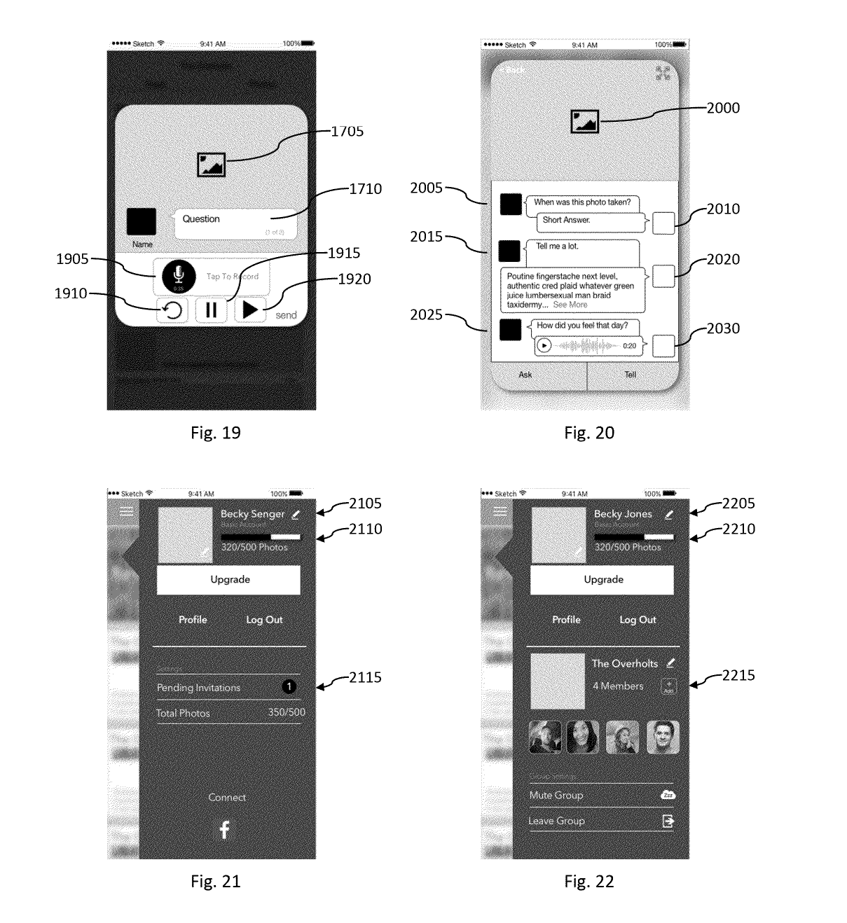

The screen shot of FIG. 19 is displayed after the user selected the “Tap to Record” button 1720 of the screen shot shown in FIG. 17. The user can select a record button 1905, a restart button 1910, a pause button 1915, or a play button 1920 that can be used to record an audio answer to the question 1710. For example, the user can select the record button 1905 to being recording audio. While recording the audio, the user can select the pause button 1915 to temporarily pause the recording of the audio. The play button 1920 can be used to play back what has been recorded. The restart button 1910 can be used to delete what has been already recorded such that the user can restart the recording. The audio recorded by the user device can be transmitted to the user that asked the question 1710. In an illustrative embodiment, the audio recorded by the user device is stored in the audio storage device 125 in connection with the photo 1705. Thus, when a user views the photo 1705 at a later time, the user can be presented with the recorded audio to replay.

FIG. 20 is a screen shot of a user interface for viewing a story. The screen shot of FIG. 20 shows an example of a conversation regarding a photo 2000. A first user can ask a first question 2005 (e.g., “When was this photo taken?”). A second user can provide a first text answer 2010. In the embodiment shown in FIG. 20, the first user can as a second question 2015 asking for additional information regarding the photo 2000. The screen shot can show a second text answer 2020. A third question 2025 can ask for further information regarding the photo 2000. The audio answer 2030 can be provided in an audio format. For example, the second user can have recorded an audio answer to the third question 2025. The user interface can allow the user of the user interface to replay the audio answer 2030.

FIGS. 21 and 22 are screen shots of user profiles in accordance with illustrative embodiments. The user profile of FIG. 21 includes a username 2105 (e.g., “Becky Senger”). The user profile can include a capacity 2110 that indicates the capacity that the user has for storing data such as photos, videos, audio recordings, questions, answers, comments, conversations, etc. In the embodiment illustrated in FIG. 21, the capacity 2110 indicates the number of photos that the user can store (e.g., 320 of 500 photos). In an illustrative embodiment, a user of the application can have a subscription service to store additional information. For example, the user can select the upgrade button to upgrade the user's subscription service, thereby allowing the user to store additional photos, videos, etc. The user profile of FIG. 21 shows pending invitations 2115. For example, the pending invitations 2115 can be invitations for the user to join a group.

The user profile of FIG. 22 includes a username 2205 (e.g., “Becky Jones”) and a capacity 2210. The user profile can show a group 2215 that the user is a member of. The information associated with the group 2215 shown in FIG. 22 shows that the group name is “The Overholts,” has four members, and has photo clips associated with the members. In an illustrative embodiment, the user can select to “Mute Group” (e.g., not receive questions from the group) or to “Leave Group.” In an illustrative embodiment, each user can be a member of only one group. In alternative embodiments, each user can be a member of multiple groups.

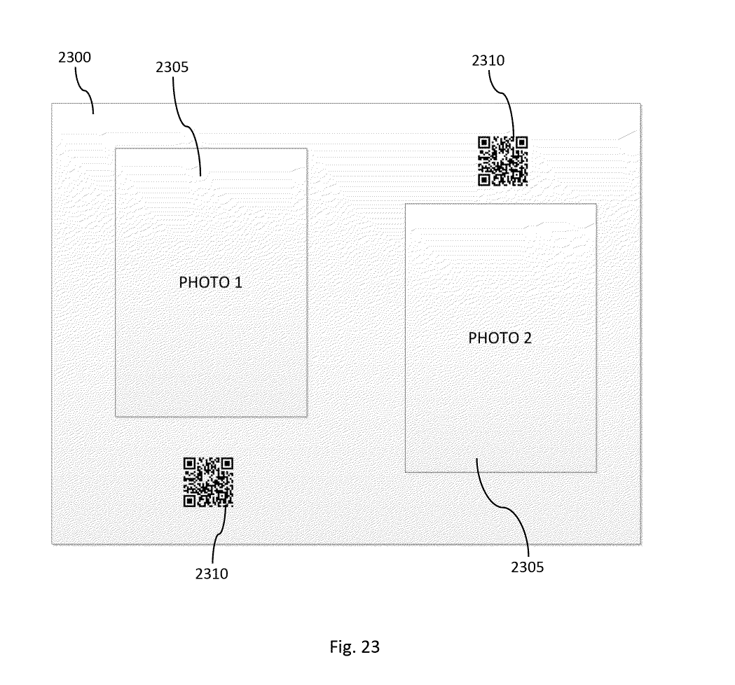

In an illustrative embodiment, one or more photos can be memorialized in a physical medium while maintaining access to associated recordings. FIG. 23 is an illustration of a photo book in accordance with an illustrative embodiment. In an illustrative embodiment, a book page 2300 includes photos 2305 and Quick Response (QR) codes 2310. As shown in FIG. 23, photos 2305 can be printed on a book page 2300. In alternative embodiments, the photos 2305 can be printed on any suitable format such as individual pages, a post card, a tee shirt, etc. Although FIG. 23 shows two photos 2305, in some embodiments, more than two or fewer than two photos 2305 can be printed. Associated with each of the photos 2305 is one of the QR codes 2310. The QR codes 2310 can be used to direct a user device to a recording corresponding to a respective one of the photos 2305. For example, a smartphone can be used to scan one of the QR codes 2310. In response to scanning the one of the QR codes 2310, the smartphone can open an application that downloads the associated recording(s) or directs the user to the application in which the user can select one or more recordings.

For example, at a wedding, an album can contain pictures of the people of the wedding party as children. Attendees to the wedding can access the album and provide recorded content (or textual messages) for one or more of the pictures. Attendees can capture their own pictures and add them to the wedding album, for example, with audio recordings or textual messages. A printed wedding album can contain some or all of the pictures of the digital album with QR codes associated with pictures for which audio was recorded or messages were submitted.

An illustrative embodiment can be used to capture stories by non-associated people, such as non-family members, nurses, staff, etc. For example, a woman in a nursing home can have one or more conditions that affect the woman's memory. However, the woman may have lucid moments in which she can remember events from her past. In an illustrative embodiment, a nurse or staff member of the nursing home can use an embodiment of the present disclosure to record a story told by the woman (e.g., during a lucid moment). In an illustrative embodiment, the nurse or staff member can use a user device such as a smartphone with an application installed that records the woman's story. In such an embodiment, the application can allow the nurse or staff member to record a story, but not allow the nurse or staff member to replay, delete, and/or edit the recording. For example, in some instances, family members may wish to have control over the recordings, not the nurse or staff member.

One or more of the embodiments described herein can contain an administrator mode that allows users such as nurses to record and store content to multiple accounts. For example, a nurse may be responsible for twenty patients. The nurse may have access to accounts associated with each of the twenty patients. The access of the nurse can be limited based on the preferences of each patient (or their family member). For example, the nurse may have the ability to record content and store the content, but not have the ability to delete content.

In an illustrative embodiment, replaying stories can be used as a therapy tool. For example, patients with one or more memory conditions (e.g., dementia or Alzheimer's disease) can be routinely upset or distressed because they are confused (e.g., caused by the memory condition such as short-term memory loss). For some patients, retelling of certain stories can be used to calm the patients. For example, telling a particular patient a story related to a fond memory of the patient may distract the patient from his or her concern (e.g., caused by short-term memory loss) to focus on the story, which the patient still remembers. Such an embodiment can be used by nursing or staff members or by family members (e.g., to remind the patient of who the person is).

Such embodiments can be used in any suitable context. For example, a parent can have recorded a story such that another caretaker (e.g., a nurse while the child is in the hospital, a staff member of a daycare, another parent while the child is at a sleep-over, etc.) can replay the caretaker and calm the child down (e.g., if the child is homesick or is missing his or her parents). In other examples, the replaying of stories can be used in any other therapeutic or clinical purposes. In such an embodiment, the nursing or staff members may have access to replay or view content, but may not have access to add or delete content. In alternative embodiments, the nurse or staff member can have any suitable amount or degree of control or privileges over the account.

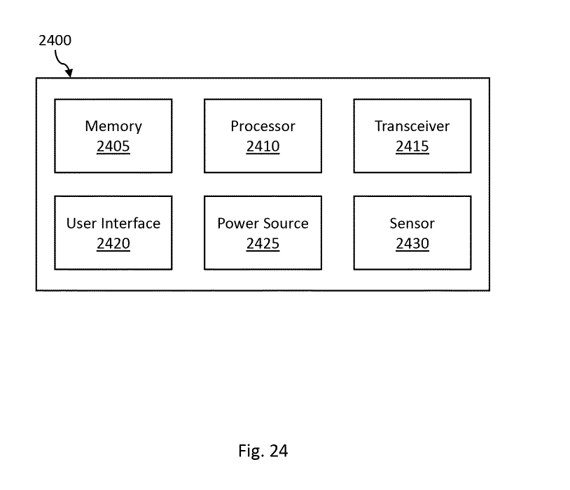

FIG. 24 is a block diagram of a computing device in accordance with an illustrative embodiment. An illustrative computing device 2400 includes a memory 2405, a processor 2410, a transceiver 2415, a user interface 2420, a power source 2425, and a sensor 2430. In alternative embodiments, additional, fewer, and/or different elements may be used. The computing device 2400 can be any suitable device described herein. For example, the computing device 2400 can be a desktop computer, a laptop computer, a smartphone, a specialized computing device, etc. The computing device 2400 can be used to implement one or more of the methods described herein.

In an illustrative embodiment, the memory 2405 is an electronic holding place or storage for information so that the information can be accessed by the processor 2410. The memory 2405 can include, but is not limited to, any type of random access memory (RAM), any type of read only memory (ROM), any type of flash memory, etc. such as magnetic storage devices (e.g., hard disk, floppy disk, magnetic strips, etc.), optical disks (e.g., compact disk (CD), digital versatile disk (DVD), etc.), smart cards, flash memory devices, etc. The computing device 2400 may have one or more computer-readable media that use the same or a different memory media technology. The computing device 2400 may have one or more drives that support the loading of a memory medium such as a CD, a DVD, a flash memory card, etc.

In an illustrative embodiment, the processor 2410 executes instructions. The instructions may be carried out by a special purpose computer, logic circuits, or hardware circuits. The processor 2410 may be implemented in hardware, firmware, software, or any combination thereof. The term “execution” is, for example, the process of running an application or the carrying out of the operation called for by an instruction. The instructions may be written using one or more programming language, scripting language, assembly language, etc. The processor 2410 executes an instruction, meaning that it performs the operations called for by that instruction. The processor 2410 operably couples with the user interface 2420, the transceiver 2415, the memory 2405, etc. to receive, to send, and to process information and to control the operations of the computing device 2400. The processor 2410 may retrieve a set of instructions from a permanent memory device such as a ROM device and copy the instructions in an executable form to a temporary memory device that is generally some form of RAM. An illustrative computing device 2400 may include a plurality of processors that use the same or a different processing technology. In an illustrative embodiment, the instructions may be stored in memory 2405.

In an illustrative embodiment, the transceiver 2415 is configured to receive and/or transmit information. In some embodiments, the transceiver 2415 communicates information via a wired connection, such as an Ethernet connection, one or more twisted pair wires, coaxial cables, fiber optic cables, etc. In some embodiments, the transceiver 2415 communicates information via a wireless connection using microwaves, infrared waves, radio waves, spread spectrum technologies, satellites, etc. The transceiver 2415 can be configured to communicate with another device using cellular networks, local area networks, wide area networks, the Internet, etc. In some embodiments, one or more of the elements of the computing device 2400 communicate via wired or wireless communications. In some embodiments, the transceiver 2415 provides an interface for presenting information from the computing device 2400 to external systems, users, or memory. For example, the transceiver 2415 may include an interface to a display, a printer, a speaker, etc. In an illustrative embodiment, the transceiver 2415 may also include alarm/indicator lights, a network interface, a disk drive, a computer memory device, etc. In an illustrative embodiment, the transceiver 2415 can receive information from external systems, users, memory, etc.

In an illustrative embodiment, the user interface 2420 is configured to receive and/or provide information from/to a user. The user interface 2420 can be any suitable user interface. The user interface 2420 can be an interface for receiving user input and/or machine instructions for entry into the computing device 2400. The user interface 2420 may use various input technologies including, but not limited to, a keyboard, a stylus and/or touch screen, a mouse, a track ball, a keypad, a microphone, voice recognition, motion recognition, disk drives, remote controllers, input ports, one or more buttons, dials, joysticks, etc. to allow an external source, such as a user, to enter information into the computing device 2400. The user interface 2420 can be used to navigate menus, adjust options, adjust settings, adjust display, etc.

The user interface 2420 can be configured to provide an interface for presenting information from the computing device 2400 to external systems, users, memory, etc. For example, the user interface 2420 can include an interface for a display, a printer, a speaker, alarm/indicator lights, a network interface, a disk drive, a computer memory device, etc. The user interface 2420 can include a color display, a cathode-ray tube (CRT), a liquid crystal display (LCD), a plasma display, an organic light-emitting diode (OLED) display, etc.

In an illustrative embodiment, the power source 2425 is configured to provide electrical power to one or more elements of the computing device 2400. In some embodiments, the power source 2425 includes an alternating power source, such as available line voltage (e.g., 120 Volts alternating current at 60 Hertz in the United States). The power source 2425 can include one or more transformers, rectifiers, etc. to convert electrical power into power useable by the one or more elements of the computing device 2400, such as 1.5 Volts, 8 Volts, 12 Volts, 24 Volts, etc. The power source 2425 can include one or more batteries.

In an illustrative embodiment, the computing device 2400 includes a sensor 2430. In an illustrative embodiment, the sensor 2430 can include an image capture device. In some embodiments, the sensor 2430 can capture two-dimensional images. In other embodiments, the sensor 2430 can capture three-dimensional images. The sensor 2430 can be a still-image camera, a video camera, etc. The sensor 2430 can be configured to capture color images, black-and-white images, filtered images (e.g., a sepia filter, a color filter, a blurring filter, etc.), images captured through one or more lenses (e.g., a magnification lens, a wide angle lens, etc.), etc. In some embodiments, sensor 2430 (and/or processor 2410) can modify one or more image settings or features, such as color, contrast, brightness, white scale, saturation, sharpness, etc. In another example, the sensor 2430 is a device attachable to a smartphone, tablet, etc. In yet another example, the sensor 2430 is a device integrated into a smartphone, tablet, etc. In an illustrative embodiment, the sensor 2430 can include a microphone. The microphone can be used to record audio, such as one or more people speaking.

In an illustrative embodiment, any of the operations described herein can be implemented at least in part as computer-readable instructions stored on a computer-readable memory. Upon execution of the computer-readable instructions by a processor, the computer-readable instructions can cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A device comprising:
a user interface configured to display information and receive user input;
a microphone configured to detect sound;
a speaker configured to transmit sound;
a transceiver configured to communicate with a database and a first user device; and
a processor operatively coupled to the user interface, the microphone, the speaker, and the transceiver, wherein the processor is configured to:
receive a first image from the database;
receive from the first user device a first message, wherein the first message includes a request for information related to the first image;
record via the microphone an audio recording that includes information related to the first image;
transmit the audio recording to the database;
transmit to the database a request for the first image;
receive the first image with an identifier of the audio recording; and
cause the user interface to display the first image and simultaneously cause the speaker to play the audio recording.

2. The device of claim 1, wherein the processor is further configured to:
cause the user interface to simultaneously display the first image and a plurality of messages, wherein the plurality of messages includes the first message; and
receive from the user interface an indication that the first message was selected.

3. The device of claim 2, wherein the processor is further configured to receive from the user interface an indication that the first message is to be sent to the first user device.

4. The device of claim 1, wherein to receive the first image with the identifier of the audio recording, the processor is configured to receive the first image with the identifier of the audio recording and a second message,
wherein the second message comprises text information related to the first image, and
wherein the processor is configured to cause the user interface to simultaneously display the first image and the second message.

5. The device of claim 1, further comprising an first image capture device, and wherein the processor is further configured to:
receive from the first image capture device the first image; and
transmit to the database the first image.

6. The device of claim 1, wherein the processor is further configured to:
receive from a second user device a third message that comprises a request for information related to a second image; and
cause the user interface to simultaneously display the second image and the third message.

7. The device of claim 1, wherein to transmit the audio recording to the database, the processor is configured to parse the audio recording into a plurality of audio files and transmit the plurality of audio files to the database individually.

8. The device of claim 1, wherein the first image is one of a plurality of images that comprise a video.

9. A method comprising:
receiving, by a processor of a first user device, a first image from a database;
receiving, by the processor, a first message from the second user device, wherein the first message includes a request for information related to the first image;
recording, by the processor and via a microphone of the first user device, an audio recording that includes information related to the first image;
transmitting the audio recording to the database;
transmitting to the database a request for the first image;
receiving the first image with an identifier of the audio recording; and
simultaneously causing, by the processor, a user interface of the first user device to display the first image and causing a speaker of the first user interface to play the audio recording.

10. The method of claim 9, further comprising
causing, by the processor, the user interface to simultaneously display the first image and a plurality of messages, wherein the plurality of messages includes the first message; and
receiving, by the processor, from the user interface an indication that the first message was selected.

11. The method of claim 10, further comprising receiving from the user interface an indication that the first message is to be sent to the third user device.

12. The method of claim 9, wherein said receiving the first image with the identifier of the audio recording comprising receiving the first image with the identifier of the audio recording and a second message,
wherein the second message comprises text information related to the first image, and
wherein the processor is configured to cause the user interface to simultaneously display the first image and the second message.

13. The method of claim 9, further comprising:
receiving the first image from a first image capture device of the first user device; and
transmitting the first image to the database.

14. The method of claim 9, further comprising:
receiving, from a fourth user device, a third message that comprises a request for information related to a second image; and
causing the user interface to simultaneously display the second image and the third message.

15. The method of claim 9, wherein said transmitting the audio recording to the database comprising parsing the audio recording into a plurality of audio files and transmit the plurality of audio files to the database individually.

16. A device comprising:
memory configured to store a first image and an audio recording;
a transceiver configured to communicate with a first user device and a second user device; and
a processor operatively coupled to the memory and the transceiver, wherein the processor is configured to:
receive from the first user device a first message, wherein the first message includes a request for information related to the image;
transmit to the second user device the first message;
receive from the second user device the audio recording, wherein the audio recording includes information related to the image and was recorded by the second user device;
cause the memory to store the audio recording with an indication that relates the audio recording to the image;
receive from the first user device a request for the image; and
in response to receiving the request for the image, transmit to the first user device the image and an identifier of the audio recording.

17. The device of claim 16, wherein the processor is further configured to receive from the first user device an indication that the first message is to be sent to the second user device.

18. The device of claim 16, wherein the processor is further configured to receive from a third user device a second message that comprises text information related to the image, and
wherein to transmit the image and the identifier, the processor is configured to transmit the image, the identifier, and the second message.

19. The device of claim 16, wherein the processor is further configured to:
receive from the first user device the first image, wherein the first image was captured by the first user device; and
transmit to the database the first image.

20. The device of claim 16, wherein to receive the audio recording, the processor is configured to individually receive a plurality of audio files.
